(19) United States
(12) Patent Application Publication
(10) Pub. No.: US 2006/0103775 A1
(43) Pub. Date: May 18, 2006

(54) Reflection sheet, backlight assembly having the reflection sheet and display device having the backlight assembly

(76) Inventor: Du-Hwan Chung, Suwon-si (KR)

Correspondence Address: CANTOR COLBURN, LLP, 55 GRIFFIN ROAD SOUTH, BLOOMFIELD, CT, 06002, US

(21) Appl. No.: 11/281,330

(22) Filed: Nov. 16, 2005

(30) Foreign Application Priority Data
Nov. 16, 2004 (KR) 2004-93654

(51) Int. Cl. G02F 1/1333

(52) U.S. Cl. 349/58

(57) ABSTRACT

A reflection sheet improving a display quality, a backlight unit including the reflection sheet and a display device including the backlight unit is provided. The reflection sheet includes a reflection layer and a heat emission layer. The reflection layer reflects a light supplied from a light source. The heat emission layer contacts the reflection layer to emit a heat generated from the light source. The heat emission insulates the light source from the receiving member to suppress a leakage current of the light source.

This application claims priority to Korean Patent Application No. 2004-93654 filed on Nov. 16, 2004, and all the benefits accruing therefrom under 35 U.S.C. §119, the contents of which are herein incorporated by reference in its entirety.

### BACKGROUND OF THE INVENTION

1. Field of the Invention

The present invention relates to a reflection sheet, a backlight assembly having the reflection sheet and a display device having the backlight assembly. More particularly, the present invention relates to a reflection sheet capable of improving a display quality, a backlight assembly having the reflection sheet and a display device having the backlight assembly.

2. Description of the Related Art

Display devices displaying an image have been widely developed. A liquid crystal display device has advantageous characteristics such as lightweight, thin thickness, low power consumption, etc. Accordingly, the liquid crystal display device is widely used in various applications.

The liquid crystal display device includes a backlight assembly and a liquid display panel. The backlight assembly provides the liquid crystal display panel with a light that enables the liquid crystal display device to display images. The liquid crystal display device is classified as either a direct illumination type backlight assembly or an edge-type backlight assembly in accordance with a position of a light source.

The edge-type backlight assembly has a lamp unit positioned on a side face of a light guide panel. The edge-type backlight assembly is used in a small liquid crystal display device such as a laptop-type computer and a desktop-type computer. The edge-typed backlight assembly uniformly generates a light and has a substantially long lifetime. In addition, the edge-typed backlight assembly is advantageously used for a substantially slim liquid crystal display device.

A plurality of lamps are arranged in parallel around a lower portion of a direct illumination type backlight assembly. Because the direct illumination type backlight assembly has the plurality of lamps providing a liquid crystal display panel with a light, the direct illumination type backlight assembly is advantageously used for a substantially large screen liquid crystal display device that requires a substantially high brightness.

However, if the large screen liquid crystal display device has the direct type backlight assembly, heat is exceedingly generated from the lamps that are positioned around the lower portion of the liquid crystal display panel. Thus, an inner temperature of a receiving member increases. The heat deteriorates a liquid crystal layer in the liquid crystal display panel. In addition, the heat decreases a luminance of the lamps so that a display quality of the liquid crystal device is deteriorated.

FIG. 1 is a graph showing a relative brightness varied in accordance with a temperature around a plurality of lamps using a conventional liquid crystal display device. Referring to FIG. 1, when the temperature is over about 45° C., a vapor pressure of mercury in the lamps is varied. Thus, the brightness of the lamp is decreased.

To overcome problems due to an increase of an inner temperature of the liquid crystal display device or due to a temperature difference between an inside and an outside of the lamps, it is necessary that the heat generated from the inside of the lamps is rapidly dissipated to the outside of the lamps. Heat generated from the lamps may be transmitted to a reflection sheet. The heat transmitted to the reflection sheet is then transmitted to a receiving member including metal so that the heat is essentially exhausted from the receiving member.

However, because the reflection sheet including synthetic resins, a heat conductivity of the reflection sheet is substantially low. Thus, the heat transmitted from the lamps is slowly transmitted to the receiving member such that the heat is inefficiently emitted from the receiving member.

In addition, the receiving member for receiving the lamps includes metal such that a parasite capacitance is generated between the receiving member and the lamps. The parasite capacitance causes a leakage current, thereby decreasing the brightness of the lamps.

### SUMMARY OF THE INVENTION

The present invention provides a reflection sheet capable of both efficiently emitting a heat therefrom and efficiently insulating a light source from a receiving member.

The present invention also provides a backlight assembly including the above reflection sheet.

The present invention still also provides a display device including the above backlight assembly.

In accordance with an exemplary embodiment of the present invention, a reflection sheet comprises a reflection layer reflecting a light supplied from a light source and a heat emission layer positioned on a face of the reflection layer. The heat emission layer disperses heat from the light source. The heat emission layer suppresses a current leakage of the light source.

In accordance with another exemplary embodiment of the present invention, the heat emission layer includes boron nitride, silicon carbide, magnesium oxide, or a combination of any of the foregoing.

In accordance with another exemplary embodiment of the present invention, the heat emission layer includes boron nitride doped with no more than about 30 weight percent of graphite, silicon carbide doped with no more than about 30 weight percent of graphite, magnesium oxide doped with no more than about 30 weight percent of graphite, or a combination of any of the foregoing.

In accordance with another exemplary embodiment of the present invention, a backlight assembly includes a light source, a receiving member and a reflection member. The light source generates a light. The receiving member is positioned under the light source to receive the light source. The reflection member is positioned between the light source and the receiving member. The reflection member emits a heat generated from the light source. The reflection member insulates the light source from the receiving member.

In accordance with still another exemplary embodiment of the present invention, a display device includes a display unit and a backlight assembly. The display unit displays images. The backlight assembly has a light source, a receiving member and a reflection member. The light source generates a light used for displaying the images. The receiving member receives the light source. The reflection member emits a heat generated from the light source. The reflection member insulates the light source from the receiving member.

In accordance with another exemplary embodiment of the present invention, a reflection sheet uniformly disperses a light and insulates a light source from a receiving container such that emission efficiency may be improved. In addition, a parasite capacitance may be suppressed. Advantageously, the reflection sheet may improve a brightness of light.

### BRIEF DESCRIPTION OF THE DRAWINGS

The above and other advantages of the present invention will become readily apparent by reference to the following detailed description when considered in conjunction with the accompanying drawings in which:

FIG. 1 is a graph showing an exemplary embodiment of relative brightness varied in accordance with a temperature around a plurality of lamps using a conventional liquid crystal display device;

FIG. 2 is an exploded perspective view illustrating an exemplary embodiment of a backlight assembly in accordance with the present invention;

FIG. 3 is a cross-sectional view taken along line I-I′ shown in FIG. 2;

FIG. 4 is a cross-sectional view illustrating an exemplary embodiment of a reflection sheet shown in FIG. 2;

FIG. 5A is a schematic view illustrating an exemplary embodiment of a thermal distribution of a conventional backlight assembly including a conventional reflection sheet;

FIG. 5B is a schematic view illustrating an exemplary embodiment of a thermal distribution of a backlight assembly having a reflection sheet in accordance with the present invention; and

FIG. 6 is an exploded perspective view illustrating an exemplary embodiment of a liquid crystal display device in accordance with the present invention.

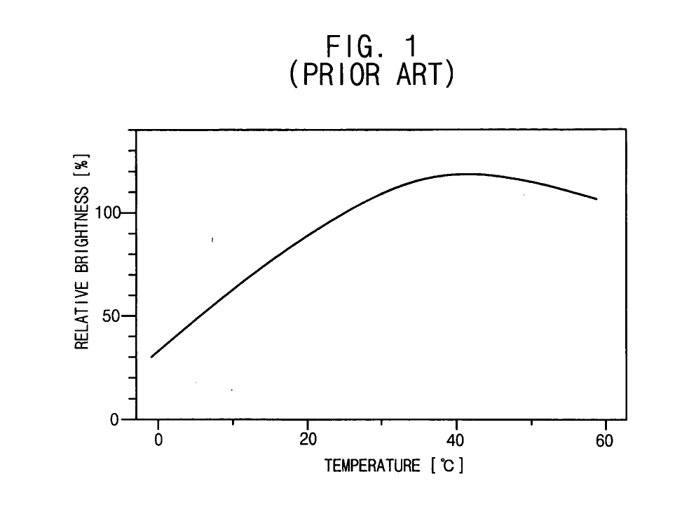

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete and will fully convey the scope of the invention to those skilled in the art. In the drawings, the thickness of layers and regions are exaggerated for clarity. Like reference numerals refer to similar or identical elements throughout. It will be understood that when an element such as a layer, region or substrate is referred to as being “on” or “onto” another element, it can be directly on the other element or intervening elements may also be present.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

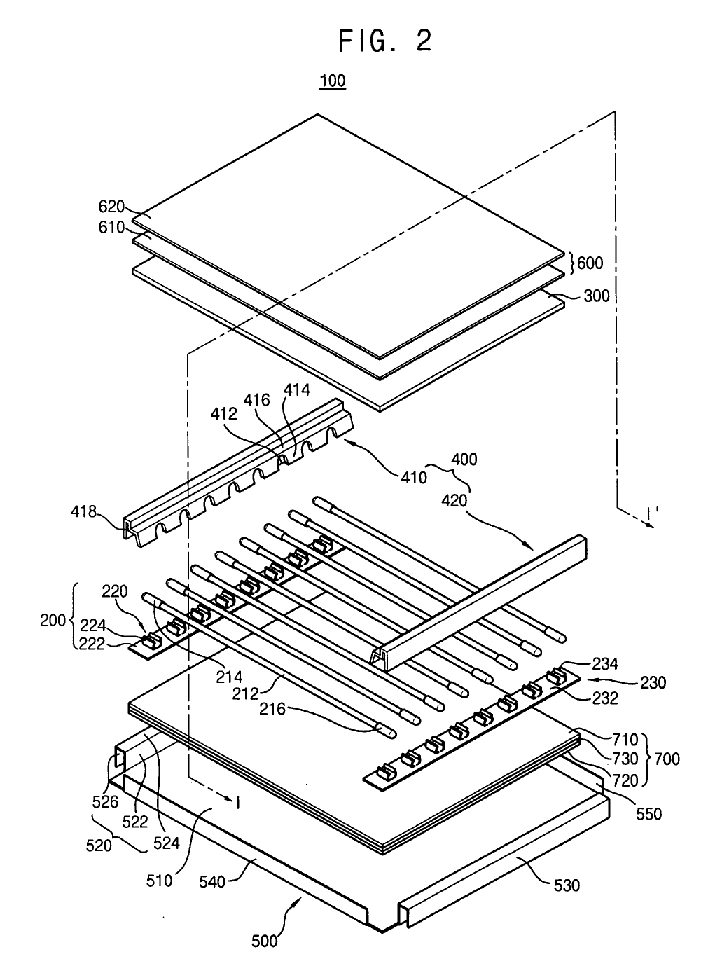

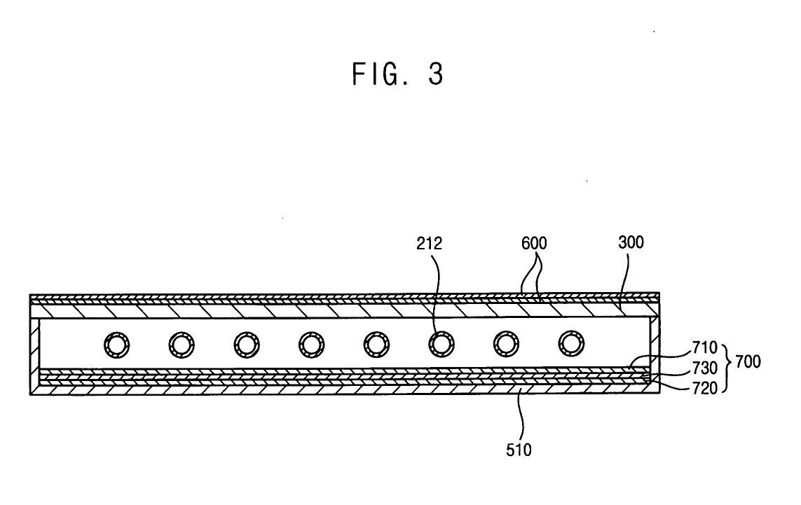

FIG. 2 is an exploded perspective view illustrating an exemplary embodiment of a backlight assembly in accordance with the present invention. FIG. 3 is a cross-sectional view taken along line I-I′ shown in FIG. 2.

Referring to FIGS. 2 and 3, a backlight assembly 100 has a lamp unit 200, a dispersion plate 300, a first receiving member 400 and a second receiving member 500. The backlight assembly 100 may further include an optical sheet 600 and a reflection sheet 700.

The lamp unit 200 has a plurality of lamps 212, and first and second outer electrodes 214 and 216. The first and second outer electrodes 214 and 216 are positioned around both ends portions of the lamps 212. In exemplary embodiments, the lamp 212 may be an external electrode fluorescent lamp (EEFL) having the first and second outer electrodes 214 and 216. In alternative embodiments, the lamp unit 200 may be a cold cathode fluorescent lamp (CCFL).

As illustrated in FIG. 3, the lamp 212 that generates light has a substantially tube shape. In other exemplary embodiments, the lamp 212 may have various shapes such as a shape of a light emission diode (LED) instead of the tube shape, or any shape suitable for the purpose described herein.

A discharge gas (not shown) may be supplied into the lamps 212. The first and second outer electrodes 214 and 216 may have a conductive material. The first and second outer electrodes 214 and 216 partially enclose the ends portions of the lamps 212. The lamps 212 generate the light in response to first and second driving voltages applied to the lamps 212 through the first and second outer electrodes 214 and 216.

The lamp unit 200 may have a first lamp holder 220 and a second lamp holder 230. The first lamp holder 220 may hold one of the end portions of the lamp 212. The second lamp holder 230 may hold the other end portion of the lamp 212.

The first lamp holder 220 may have a first fixing plate 222 and a plurality of first clip portions 224. The first clip portions 224 are protruded from the first fixing plate 222. Each of the first outer electrodes 214 is joined with each of the first clip portion 224 to hold one of the end portions of the lamp 212. In addition, the first fixing plate 222 is connected with the first clip portions 224 such that the first fixing plate 222 can provide the first clip portions 224 with the first driving voltage. In exemplary embodiments, a plurality of ancillary clip portions (not shown) may protrude from the first fixing plate 222. The ancillary clip portion may prevent, or effectively reduce, the lamp 212 held by the first clip portion 224 from moving. In alternative exemplary embodiments, the ancillary portion may contact the end portion of the lamp 212.

The second lamp holder 230 holding the other end portion of the lamp 212 has a second fixing plate 232 and a plurality of second clip portions 234. The second clip portions 234 are protruded from the second fixing plate 232. Each of the second outer electrodes 216 is joined with each of the second clip portion 234 to hold the other end portion of the lamp 212. In addition, the second fixing plate 232 is connected with the second clip portions 234 such that the second fixing plate 232 can provide the second clip portions 234 with the second driving voltage. In exemplary embodiments, a plurality of the ancillary clip portions discussed above for the first lamp holder 220 may protrude from the second fixing plate 232. The ancillary clip portion may prevent, or effectively reduce, the lamp 212 held by the second clip portion 234 from moving. In alternative exemplary embodiments, the ancillary portion may contact the end portion of the lamp 212.

In another exemplary embodiment, insulation members (not shown) that may include, but are not limited to, an insulation material may be positioned beneath the first lamp holder 220, the second lamp holder 230 or both. The insulation members effectively insulate the first lamp holder 220 and the second lamp holder 230 from the second receiving member 500.

Referring to FIGS. 2 and 3, the dispersion plate 300 is positioned over the lamp unit 200. A first light generated from the lamps 212 is incident on the dispersion plate 300. The dispersion plate 300 then disperses the first light so that the first light may be changed into a second light having a uniform brightness. Thereafter, the second light is irradiated from the dispersion plate 300.

The first receiving member 400 is positioned under the dispersion plate 300. The first receiving member 400 may include a first mold frame 410 and a second mold frame 420.

The first mold frame 410 is positioned directly over the first lamp holder 220. The second mold frame 420 is positioned directly over the second lamp holder 230.

Referring again to FIGS. 2 and 3, a width of a lower portion of the first mold frame 410 is substantially larger than that of an upper portion of the first mold frame 410. The first outer electrode 214 may be sufficiently received in the first mold frame 410. The first mold frame 410 has a first sidewall 414, a stepped portion 416 and a second sidewall 418. The first sidewall 414 has recesses 412 into which the lamps 212 are inserted. The stepped portion includes a first substantially horizontal portion extended from an upper portion of the first sidewall 414 towards the second sidewall 418 such that the stepped portion essentially supports the dispersion plate 300 and the optical sheet 600. The stepped portion 416 as illustrated in FIG. 2 also includes a second substantially horizontal portion extending from an upper portion of the second sidewall 418 toward the first horizontal portion and a substantially vertical portion between the first and second horizontal portions. The second sidewall 418 is vertically extended from the stepped portion towards the second receiving member 500.

The first mold frame 410 has a first receiving space defined by the first sidewall 414, the stepped portion 416 and the second sidewall 418. The first lamp holder 220 is received in the first receiving space.

The second mold frame 420 is substantially identical to the first mold frame 410. Thus, further detailed explanation will be omitted. The second mold frame 420 has a second receiving space therein. The second lamp holder 230 is received in the second receiving space.

The second receiving member 500 positioned below the lamp unit 200 has a bottom portion 510, a first sidewall portion 520, a second sidewall portion 530, a third sidewall portion 540 and a fourth sidewall portion 550. The first, second, third and fourth sidewall portions 520, 530, 540 and 550 are substantially vertically extended from the bottom portion 510 towards the dispersion plate 300. The bottom portion 510 and the first, second, third and fourth sidewall portions 520, 530, 540 and 550 together define a receiving region. The lamp unit 200 and the reflection sheet 700 are received in the receiving region. The first mold frame 410 makes contact with the first sidewall portion 520 of the second receiving member 500. The second mold frame 420 makes contact with the second sidewall portion 530 of the second receiving member 500. In exemplary embodiments, the second receiving member 500 may include, but is not limited to, a metal. The second receiving member 500 is hereinafter referred to as a bottom chassis.

The first sidewall portion 520 has a first side face 522, a top face 524 and a second side face 526. The first side face 522 is extended from the bottom portion 510 toward the dispersion plate 300. The top face 524 is extended from the first side face 522 toward the second side face 526 and substantially in parallel with the bottom portion 510. The second side face 526 is extended from the top face 524 toward the bottom portion 510 and is substantially parallel to and opposite of the first side face 522. The second sidewall portion 530 opposite to the first sidewall portion 520 is substantially identical to the first sidewall portion 520. Thus, further detailed explanation will be omitted.

Referring to FIGS. 2 and 3, the optical sheet 600 is positioned on the dispersion plate 300. The optical sheet 600 improves optical characteristics of the second light having substantially uniform brightness. In exemplary embodiments, the optical sheet 600 may have a dispersion sheet 610 and a prism sheet 620. The dispersion sheet 610 may be positioned on the dispersion plate 300. The dispersion sheet 610 uniformly disperses the second light irradiated from the dispersion plate 300. The prism sheet 620 may be positioned on the dispersion sheet 610. The prism sheet 620 concentrates the second light passing through the dispersion sheet 610 such that the brightness of the second light may be effectively increased.

The reflection sheet 700 is positioned beneath the lamp unit 200. The reflection sheet 700 reflects a light irradiated from the lamps 212 of the lamp unit 200 through the reflection sheet 700 so that the light may be incident on the dispersion plate 300. In exemplary embodiments, the reflection sheet 700 may have a multiplayer structure such that a heat generated from the lamps 212 is sufficiently dispersed and then transmitted into the bottom chassis 500. The reflection sheet 700 may have a reflection layer 710, a heat emission layer 720 and an adhesion layer 730. In alternative embodiments, the reflection sheet 700 may cover the third and fourth sidewall portions 540 and 550.

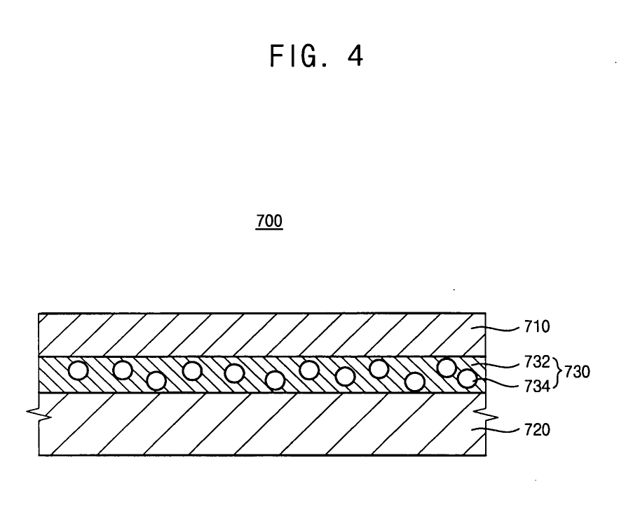

FIG. 4 is a cross-sectional view illustrating an exemplary embodiment of the reflection sheet shown in FIG. 2.

As illustrated in FIG. 4, the reflection sheet 700 has the reflection layer 710. The reflection layer 710 reflects the light irradiated from the lamps 212 shown in FIG. 2 to the reflection layer 710 and the heat emission layer 720 that is positioned under the reflection layer 710 to emit the heat generated from the lamps 212.

The reflection layer 710 may include, but is not limited to, polyethylene terephthalate (PET) having a reflective characteristic. The reflection layer 710 reflects the light irradiated from the lamps 212 of the lamp unit 200 to the reflection layer 710 so that the light may be incident on the dispersion plate 300 (see FIG. 2). Advantageously, a usage efficiency of light may be improved. In exemplary embodiments, the reflection layer 710, including the PET, may be coated on the heat emission layer 720.

The heat emission layer 720 may disperse the heat generated from the lamps 212 such that the heat may be effectively emitted from the heat emission layer 720. In addition, the heat emission layer 720 enables the bottom chassis 500 to be electrically insulated from the lamps 212 such that a parasitic capacitance due to a leakage current may be suppressed, or effectively reduced.

The heat emission layer 720 may have a material having both a substantially high heat conductivity and a substantially high electrical resistance. In exemplary embodiments, the material may be boron nitride (BN), silicon carbide (SiC) or magnesium oxide (MgO). These may be used alone or in a mixture thereof. In alternative embodiments, graphite may be doped into the material at a predetermined concentration. A weight percent of the graphite included in BN, SiC or MgO may be no more than about 30.

BN, SiC or MgO has substantially high heat conductivity. A heat conductivity of the BN is about 400 W/mK. A heat conductivity of SiC is about 300 W/mK. A heat conductivity of MgO is about 200 W/mK.

In addition, BN, SiC or MgO has substantially high electrical resistivity. An electrical resistivity of BN is about 2×10¹⁴ ohm·cm. An electrical resistivity of the SiC is about 10⁵ ohm·cm. An electrical resistivity of MgO is about 10⁹ ohm·cm.

Advantageously, the heat emission layer 720, including the above described material, may uniformly disperse the heat generated from the first and second outer electrodes 214 and 216 of the lamps 212. The heat is then rapidly transmitted to bottom chassis 500. In addition, the heat emission layer 720 may electrically insulate the bottom chassis 500 from the lamps 212.

A heat conductivity of the graphite is relatively high. However, an electrical resistivity of the graphite is relatively low. For example, where the heat emission layer 720 has the material doped with the graphite at a predetermined concentration, the heat emission layer 720 may have an electrical resistivity substantially higher than that of the graphite. Advantageously the heat emission layer 720 may effectively insulate the lamps 212 from the bottom chassis 500.

The reflection layer 710 may have thickness of about 0.01 millimeter (mm) to about 0.7 millimeter (mm). The heat emission layer 720 may have thickness of about 0.3 mm to about 0.99 mm. In exemplary embodiments, the reflection layer 710 may have thickness of about 0.25 mm and the heat emission layer 720 may have thickness of about 0.75 mm. Thus, the reflection sheet 700 may have an overall thickness of about 1 mm.

Referring to FIG. 4, the reflection sheet 700 includes the adhesion layer 730 positioned between the reflection layer 710 and the heat emission layer 720. The adhesion layer 730 may be used for laminating the heat emission layer 720 to a lower face of the reflection layer 710. The reflection layer 710 and the heat emission layer 720 may be integrally formed with each other using the adhesion layer 730.

The adhesion layer 730 may include glue 732 and air bubbles 734 arranged in the glue 732 at random. In exemplary embodiments, a blowing agent may form the air bubbles 734. The adhesion layer 730 may be formed using the glue 732 and a compound including the blowing agent. The air bubbles 734 scatter the light irradiated from the lamps 212 to the air bubbles 734. Advantageously, the adhesion layer 730 enables the reflection layer 710 and the heat emission layer 720 to be integrally formed with each other. In addition, the air bubbles 734 scatter the light to improve a reflective characteristic of the light.

The reflection sheet 700 is positioned between the lamp unit 200 and the bottom chassis 500. The reflection sheet 700 reflects the light irradiated from a lower portion of the lamp unit 200 to the reflection layer 710 such that the light may be incident on the dispersion plate 300.

In addition, the reflection sheet 700 disperses the heat generated around the first and second outer electrodes 214 and 216 of the lamps 212. The reflection sheet 700 then enables the heat to be effectively transmitted to the bottom chassis 500 such that an emitting efficiency may be increased. That is, the heat generated from the lamps 212 is transmitted to the reflection layer 710 of the reflection sheet 700. The heat that is transmitted to the reflection layer 710 is then transmitted to the heat emission layer 720. The heat emission layer 720 uniformly disperses the heat. The heat that is uniformly dispersed is transmitted to the bottom portion 510 of the bottom chassis 500. The heat that is transmitted to the bottom portion 510 of the bottom chassis is then emitted.

Because the heat emission layer 720 of the reflection sheet 700 may include the material having the substantially high electrical resistivity, the lamps 212 may be electrically insulated from the bottom chassis 500. Advantageously, the parasite capacitance may be suppressed, or effectively reduced. As a result, a leakage current may be reduced so that a brightness of the lamps 212 may be maintained or decrease only slightly.

In addition, the adhesion layer 730 having the air bubbles 734 is positioned between the reflection layer 710 and the heat emission layer 720 such that the light may be scattered by the air bubbles 734. Advantageously, the brightness of the light may be substantially high without aid of the prism sheet 620 included in the optical sheet 600 to improve the brightness of the light. In alternative embodiments, the prism sheet 620 may be omitted.

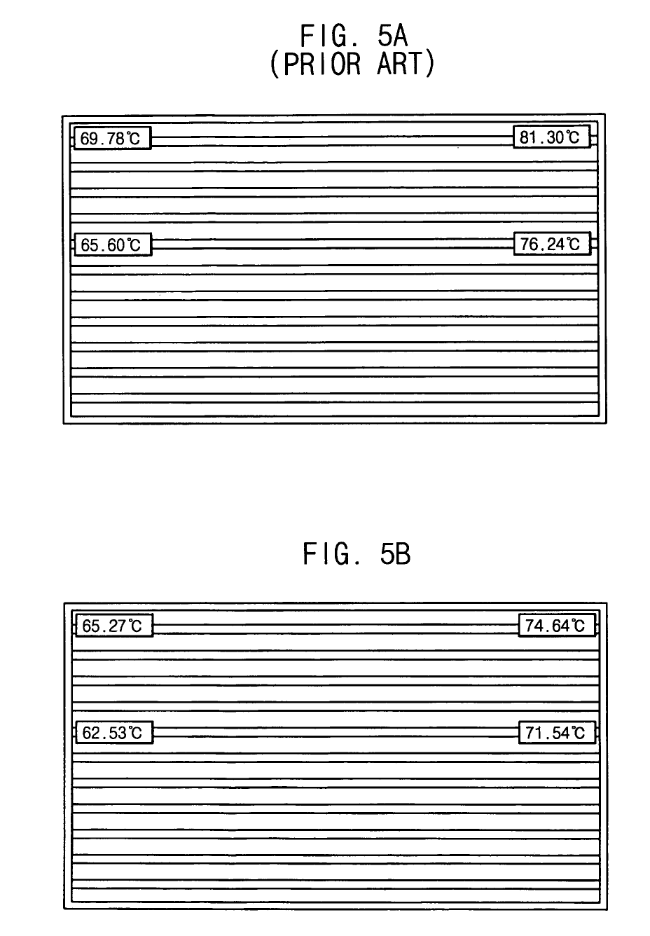

FIG. 5A is a schematic view illustrating an exemplary embodiment of a thermal distribution of a conventional backlight assembly including a conventional reflection sheet. FIG. 5B is a schematic view illustrating an exemplary embodiment of a thermal distribution of a backlight assembly including a reflection sheet in accordance with the present invention.

As illustrated in FIGS. 5A and 5B, a temperature of a right region of the backlight assembly including the reflection sheet in accordance with the present invention is lower than that of a right region of the conventional backlight assembly including the conventional reflection sheet by about 4° C. to about 7° C. One of the outer electrodes 214, 216 is positioned around the right region.

In addition, a temperature of a left region of the backlight assembly including the reflection sheet in accordance with the present invention is lower than that of a left region of the conventional backlight assembly including the conventional reflection sheet by about 3° C. to about 4° C. The other outer electrode is positioned around the left region.

As described above, in exemplary embodiments according to the present invention, temperatures of the left and right regions around outer electrodes of the backlight assembly may be effectively decreased. In addition, a degree of a temperature decrease around the right region may be higher than that around the left region in the exemplary embodiment illustrated in FIG. 5B. Thus, the backlight assembly may have a more uniform temperature than that of the conventional backlight assembly illustrated in FIG. 5A.

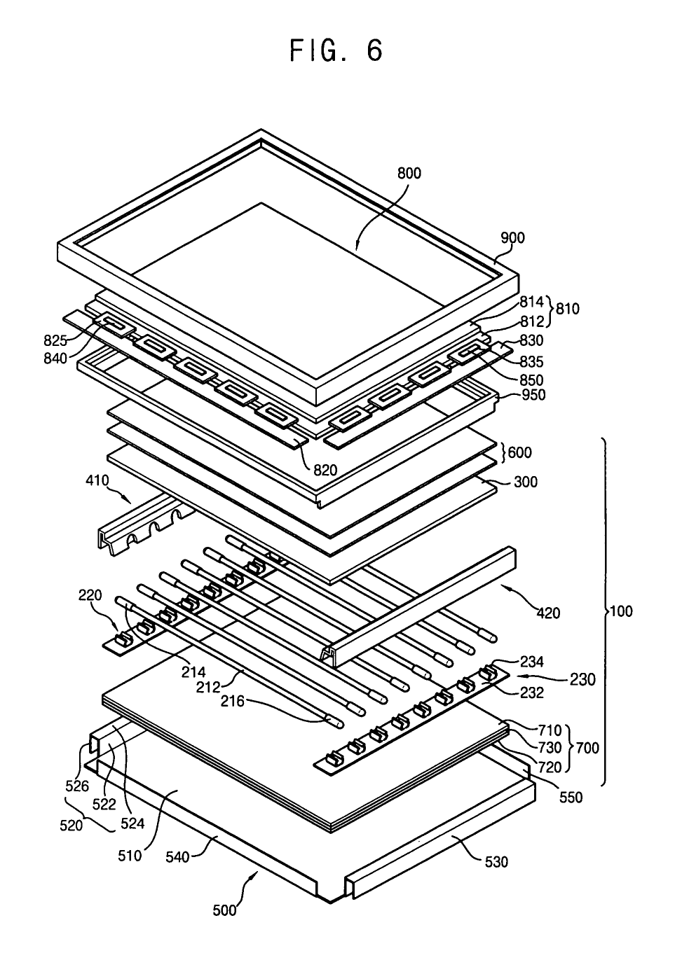

FIG. 6 is an exploded perspective view illustrating an exemplary embodiment of a liquid crystal display device. A backlight assembly in the liquid crystal display device is substantially identical to that illustrated in FIGS. 2 to 4. Thus, the same reference numerals will be used to refer to the same or like parts as those described in FIGS. 2. to 4 and further detailed explanation will be omitted.

Referring to FIG. 6, the liquid crystal display device includes a backlight assembly 100 supplying a light, a display unit 800 displaying images by using the light supplied from the backlight assembly 100, and a top chassis 900 fixing the display unit 800 to the backlight assembly 100.

The backlight assembly 100 has a lamp unit 200, a dispersion plate 300, and a bottom chassis 500. The lamp unit 200 generates the light. The dispersion plate 300 is positioned over the lamp unit 200 such that the dispersion plate 300 may disperse the light generated from the lamp unit 200. The bottom chassis 500 receives the dispersion plate 300 and the lamp unit 200. The backlight assembly 100 has an optical sheet 600 and a reflection sheet 700. The optical sheet 600 is positioned on the dispersion plate 300. The optical sheet 600 improves optical characteristics of the light. The reflection sheet 700 is positioned between the lamp unit 200 and the bottom chassis 500. The reflection sheet 700 reflects a light irradiated from the lamp unit 200. In addition, the reflection sheet 700 disperses a heat generated from the lamp unit 200.

The reflection sheet 700 has a reflection layer 710 and an adhesion layer 730. The adhesion layer 730 is positioned between the reflection layer 710 and a heat emission layer 720. The adhesion layer 730 essentially laminates the heat emission layer 720 to the reflection layer 710.

The reflection layer 710 may include, but is not limited to, polyethylene terephthalate (PET). The heat emission layer 720 may include, but is not limited to, a material having high thermal conductivity and high electrical resistivity. The material may be boron nitride (BN), silicon carbide (SiC) or magnesium oxide (MgO). Theses may be used alone or in a mixture thereof. In alternative embodiments, graphite may be doped into the material at a predetermined concentration. The adhesion layer 730 may have glue 732 having air bubbles 734 therein. The air bubbles 734 may be arranged in the glue 732 at random.

The reflection sheet 700 reflects the light irradiated from the lamp unit 200 to the reflection layer 710 such that the light may be incident on the dispersion plate 300. The air bubbles 734 included in the adhesion layer 730 of the reflection sheet 700 scatter the light so that a reflective efficiency may be improved.

In addition, the reflection sheet 700 uniformly disperses a heat generated from the first and second outer electrodes 214 and 216 of the lamps 212. The reflection sheet 700 then transmits the heat to a bottom chassis 500. Thus, the heat generated from the first and second outer electrodes 214 and 216 may be advantageously emitted.

A display panel unit 800 includes a liquid display panel 810, a source printed circuit board 820 and a gate printed circuit board 830. The liquid display panel 810 displays images. The source printed circuit board 820 and a gate printed circuit board 830 provide the liquid display panel 810 with a drive signal.

The liquid display panel 810 includes a thin film transistor (TFT) board 812, a color filter board 814 and a liquid crystal layer (not shown). The color filter board 814 may be combined with the TFT board 812. The liquid crystal layer is positioned between the TFT board 812 and the color filter board 814.

In exemplary embodiments, the TFT board 812 may be a transparent glass board in which at least one TFT (not shown) is arranged in a substantially matrix shape. The TFT is a kind of a switching device. A source terminal of the TFT is connected with a data line. A gate terminal of the TFT is connected with a gate line. A drain terminal of the TFT is connected with a pixel electrode that has a transparent and conductive material.

The color filter board 814 may be spaced apart form the TFT board 812. In addition, the color filter board 814 may be opposite to the TFT board 812. In exemplary embodiments, RGB pixels (not shown) may be formed in the color filter board 814 by a thin film process. When a light passes through the RGB pixels, the RGB pixels may present a predetermined color. In other exemplary embodiments, a common electrode that having a conductive material may be formed on a front face of the color filter board 814.

When power is applied to the gate terminal of the TFT, the liquid display panel 810 may be turned on. When the liquid display panel 810 is turned on, a magnetic field is formed between a pixel electrode and the common electrode. The magnetic field may rearrange liquid crystal molecules of the liquid crystal layer positioned between the TFT board 812 and the color filter board 814. When the liquid crystal molecules are rearranged by the magnetic field, a transmittance of a light supplied from the backlight assembly 100 to the liquid crystal layer may vary in accordance with rearrangements of the liquid crystal molecules. Advantageously, the liquid crystal panel 810 may efficiently display a desired image.

The drive signal supplied from the source printed circuit board 820 and the gate printed circuit board 830 may be applied to the liquid display panel 810 through a data flexible circuit film 825 and a gate flexible circuit film 835. The data flexible circuit film 825 may include, but is not limited to, a tape carrier package (TCP) or a chip on film (COF). The gate flexible circuit film 835 may also include, but not be limited to, a tape carrier package (TCP) or a chip on film (COF). The data flexible circuit film 825 and the gate flexible circuit film 835 may have a data drive chip 840 and a gate drive chip 850, respectively. The data drive chip 840 and the gate drive chip 850 may apply the drive signal that is supplied from the source printed circuit board 820 and the gate printed circuit board 830 to the liquid display panel 810 at a required timing.

The display unit 800 is mounted on the backlight assembly 100. The liquid display panel 810 is received in an upper mold frame 950. The liquid display panel 810 received in the upper mold frame 950 is positioned on the backlight assembly 100. The data flexible circuit film 825 is bent such that the source printed circuit board 820 is fixed on a back face of the bottom chassis 500.

The top chassis 900 encloses an edge portion of the backlight assembly 100 such that the top chassis 900 may be combined with the bottom chassis 500. The top chassis 900 may prevent, or effectively reduce, the liquid display panel 810 from being damaged by impacts. In addition, the top chassis 900 may fix the liquid display panel 810 thereto such that the liquid display panel 810 may be maintained in close proximity to the bottom chassis 500, with minimal separation.

In exemplary embodiments according to the present invention, a backlight assembly has a reflection sheet including a material of high heat conductivity and high electrical resistivity. The reflection sheet has a reflection layer, a heat emission layer, and an adhesion layer. The heat emission layer may include boron nitride (BN), silicon carbide (SiC), magnesium oxide (MgO) or any combination thereof.

Advantageously, a heat generated from lamps is uniformly dispersed such that a temperature difference between first electrodes portions of the lamps and second electrodes portions of the lamps may be reduced. Voltages applied to the first electrode portions are substantially larger than those applied to the second electrodes portions. A brightness distribution of a liquid crystal display device may be uniform.

In addition, the reflection sheet rapidly disperses the heat such that the heat generated from the lamps may be rapidly transmitted to a bottom chassis. As a further advantage, the reflection sheet may suppress, or effectively reduce, an increase of an inner temperature of the backlight assembly. In addition, a brightness of the lamps may be maintained or decrease only slightly. Furthermore, a display quality of the liquid crystal display device may be improved.

The reflection sheet insulates the lamps from the bottom chassis such that parasitic capacitances resulting in a leakage current are minimal. Advantageously, a decrease of the brightness of the backlight assembly due to the leakage current may be prevented, or effectively reduced.

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A reflection sheet comprising;
a reflection layer reflecting light supplied from a light source; and
a heat emission layer positioned on at least a face of the reflection layer, the heat emission layer dispersing heat from the light source and suppressing a current leakage of the light source.

2. The reflection sheet of claim 1, wherein the heat emission layer comprises a heat conductivity no less than about 200 W/mK and a material comprising an electrical resistivity no less than about 10¹⁴ ohm·cm.

3. The reflection sheet of claim 1, wherein the heat emission layer comprises one of boron nitride, silicon carbide, magnesium oxide and a combination including at least one of the foregoing.

4. The reflection sheet of claim 1, wherein the heat emission layer comprises one of boron nitride doped with no more than about 30 weight percent of graphite, silicon carbide doped with no more than about 30 weight percent of graphite, magnesium oxide doped with no more than about 30 weight percent of graphite and a combination including at least one of the foregoing.

5. The reflection sheet of claim 1, further comprising an adhesion layer disposed between the heat emission layer and the reflection layer, the adhesion layer combining the heat emission layer and the reflection layer with each other.

6. The reflection sheet of claim 5, wherein the adhesion layer comprises a glue comprising air bubbles arranged in the adhesion layer at random.

7. The reflection sheet of claim 1, wherein the reflection layer comprises polyethylene terephthalate.

8. The reflection sheet of claim 1, wherein the heat emission layer is positioned beneath a lower face of the reflection layer.

9. The reflection sheet of claim 1, wherein the reflection layer comprises a first thickness and the heat emission layer comprises a second thickness larger than the first thickness.

10. The reflection sheet of claim 9, wherein the first thickness is about 0.25 mm and the second thickness is about 0.75 mm.

11. A backlight assembly comprising:
a light source generating a light;
a receiving member positioned under the light source to receive the light source; and
a reflection member positioned between the light source and the receiving member, the reflection member emitting a heat generated from the light source and insulating the light source from the receiving member.

12. The backlight assembly of claim 11, wherein the reflection member comprising:
a reflection layer reflecting the light; and
a heat emission layer formed on a face of the reflection layer, the heat emission layer dispersing heat from the light source and suppressing a leakage current of the light source.

13. The backlight assembly of claim 12, wherein the heat emission layer comprises one of boron nitride, silicon carbide, magnesium oxide and a combination including at least one of the foregoing.

14. The backlight assembly of claim 12, wherein the heat emission layer comprises one of boron nitride doped with no more than about 30 weight percent of graphite, silicon carbide doped with no more than about 30 weight percent of graphite, magnesium oxide doped with no more than about 30 weight percent of graphite and a combination including at least one of the foregoing.

15. The backlight assembly of claim 12, further comprising an adhesion layer formed between the heat emission layer and the reflection layer, the adhesion layer combining the heat emission layer and the reflection layer.

16. The backlight assembly of claim 15, wherein the adhesion layer comprises a glue comprising air bubbles are arranged in the adhesion layer at random.

17. The backlight assembly of claim 11, wherein the receiving member comprises a bottom chassis including a metal.

18. A display device comprising:
a display unit displaying images; and
a backlight assembly comprises a light source, a first receiving member and a reflection member, the light source generating a light used for displaying the image, the first receiving member receiving the light source, and the reflection member emitting a heat generated from the light source and insulating the light source from the first receiving member.

19. The display device of claim 18, wherein the reflection member comprises;
a reflection layer reflecting the light; and
a heat emission layer formed on a face of the reflection layer, the heat emission layer dispersing heat from the light source and suppressing a current leakage of the light source.

20. The display device of claim 19, wherein the reflection member comprises an adhesion layer, the adhesion layer being positioned between the heat emission layer and the reflection layer to combine the heat emission layer and the reflection layer therewith.

21. The display device of claim 18, wherein the backlight assembly further comprises:
dispersion member positioned over the light source; and
a second receiving member positioned under the dispersion member and making contact with the first receiving member.

22. The display device of claim 21, wherein the second receiving member comprises a first frame member comprising a first receiving space receiving the light source and a stepped portion supporting the dispersion member.

23. The display device of claim 22, wherein the second receiving member comprises a second frame member comprising a second receiving space receiving the light source and a stepped portion supporting the dispersion member.

24. The display device of claim 18 further comprising:
a printed circuit board and a flexible circuit film, wherein the flexible circuit film is disposed fixing the printed circuit board on a bottom face of the first receiving member.
